(19) United States
(12) Patent Application Publication
(10) Pub. No.: US 2020/0044541 A1
(43) Pub. Date: Feb. 6, 2020

(54) LINEAR ACTUATOR

(71) Applicant: NIDEC SANKYO CORPORATION, NAGANO (JP)

(72) Inventors: TADASHI TAKEDA, NAGANO (JP); HIROSHI KITAHARA, NAGANO (JP); MASAO TSUCHIHASHI, NAGANO (JP)

(21) Appl. No.: 16/300,549

(22) PCT Filed: Aug. 3, 2017
(86) PCT No.: PCT/JP2017/028226

§ 371 Date: Nov. 10, 2018

(30) Foreign Application Priority Data
Aug. 9, 2016 (CN) 2016-156896

(51) Int. Cl. H02K 33/18; H02K 33/16

(52) U.S. Cl. CPC H02K 33/18; B06B 1/045; H02K 33/16

(57) ABSTRACT

A linear actuator can properly drive a movable body even if a viscoelastic body is provided between the movable body and a fixed body. For example, a linear actuator 1 includes a fixed body 2, a movable body 6, a magnetic drive mechanism 5 configured to linearly drive the movable body 6 with respect to the fixed body 2, and a viscoelastic body 9 made of a silicone gel or the like where the viscoelastic body 9 is arranged between the fixed body 2 and the movable body 6. In a case 3 of the fixed body 2 and a first yoke 7 of the movable body 6, the viscoelastic body 9 is arranged between a fixed body side flat surface unit (such as a first fixed plate 331 and a second fixed plate 332) facing parallel to a first direction and a second direction Y orthogonal to a drive direction Z by the magnetic drive mechanism 5 and a movable body side flat surface unit (such as a first side plate unit 76 and a second side plate unit 77). Therefore, when the movable body 6 is driven, the movable body 6 undergoes shear deformation.

### TECHNICAL FIELD

The present invention relates to a linear actuator configured to linearly drive a movable body.

### BACKGROUND ART

In the field of mobile telephones and the like, a device for notifying an incoming call and the like by vibration is employed, and as such a device, a linear actuator in which a movable body is supported on a fixed body via a spring member can be employed (see Patent Documents 1 and 2). In the linear actuator described in Patent Documents 1 and 2, the movable body is driven in an axial direction by a magnet provided at a movable body side and a coil provided at a fixed body side. However, in the above-mentioned linear actuators, there is a resonance point peak resulting from the spring member, and at this resonance point peak, there is a possibility that the movable body excessively displaces to collide with the fixed body.

On the other hand, to suppress a resonance peak of the movable body, it has been proposed to arrange a silicone gel (viscoelastic body) at a location sandwiched between the fixed body and the movable body in the axial direction (Patent Document 3).

### PRIOR ART DOCUMENT

### Patent Document

Patent Document 1: Japanese Unexamined Patent Application Publication No. 2006-007161
Patent Document 2: Japanese Unexamined Patent Application Publication No. 2015-008573
Patent Document 3: Japanese Unexamined Patent Application Publication No. H11-044342

### SUMMARY OF THE INVENTION

### Technical Problem

In the linear actuator described in Patent Documents 1 and 2, when the silicone gel (viscoelastic body) described in Patent Document 3 is arranged at a location sandwiched between the fixed body and the movable body in the axial direction, the viscoelastic body expands and contracts as the movable body moves in the axial direction. In this case, there is a problem that since a magnitude of a force applied by a damper to the movable body greatly changes in the course of expansion and contraction of the damper, the movable body cannot be appropriately driven, such as a linearity in a drive characteristic of the movable body is impaired.

In view of the above problems, an object of the present invention is to provide a linear actuator capable of appropriately driving a movable body even if a viscoelastic body is provided between the movable body and a fixed body.

### Solution to Problem

In order to solve the above problem, a linear actuator according to the present invention includes a fixed body, a movable body, a magnetic drive mechanism configured to linearly drive the movable body with respect to the fixed body, and a viscoelastic body provided between the fixed body and the movable body. The fixed body includes a fixed body side first flat surface unit facing a first direction orthogonal to the drive direction and a fixed body side second flat surface unit facing parallel, in the first direction, to the first flat surface unit, the movable body includes a movable body side first flat surface unit facing parallel, in the first direction, to the fixed body side first flat surface unit, and a movable body side second flat surface unit facing parallel, in the first direction, to the fixed body side second flat surface unit, and the viscoelastic body is provided between the fixed body side first flat surface unit and the movable body side first flat surface unit and between the fixed body side second flat surface unit and the movable body side second flat surface unit.

In the present invention, a viscoelastic body is provided between a fixed body and a movable body, and the viscoelastic body is arranged between the fixed body side flat surface unit (the fixed body side first flat surface unit and the fixed body side second flat surface unit) facing a first direction orthogonal to a drive direction in the fixed body, and the movable body side flat surface unit (the movable body side first flat surface unit and the movable body side second flat surface unit) facing parallel, in the first direction, to the fixed body side flat surface unit in the movable body. Therefore, when the movable body moves in the drive direction, the viscoelastic body undergoes shear deformation, and a generated restoring force is applied to the movable body. Here, the restoring force occurring when the viscoelastic body undergoes the shear deformation is smaller in degree of deformation than the restoring force when the viscoelastic body is expanded or contracted. Therefore, when the movable body moves, a change in magnitude of the restoring force received by the movable body from the viscoelastic body is small. Therefore, since the viscoelastic body stabilizes a stable damper characteristic, the movable body can be properly driven. In addition, since the viscoelastic body is provided on the flat surface unit (the fixed body side flat surface unit and the movable body side flat surface unit), the viscoelastic body can be fixed to the fixed body side and the movable body side without generating a gap or the like. Therefore, even if the movable body is repeatedly vibrated, it is less likely that a problem such as peeling of the viscoelastic body from the fixed body side or the movable body side occurs. In addition, the fixed body side flat surface unit and the movable body side flat surface unit are facing parallel with each other, and thus, the viscoelastic body applies a substantially constant restoring force to the movable body throughout the entire body, so that the viscoelastic body stabilizes the damper characteristic.

In the present invention, it is possible to adopt an aspect where the fixed body includes a fixed body side third flat surface unit facing a second direction orthogonal to the drive direction and the second direction and a fixed body side fourth flat surface unit facing parallel, in the second direction, to the fixed body side third flat surface unit, the movable body includes a movable body side third flat surface unit facing parallel, in the second direction, to the fixed body side third flat surface unit, and a movable body side fourth flat surface unit facing parallel, in the second direction, to the fixed body side second flat surface unit, and the viscoelastic body is further arranged between the fixed body side third flat surface unit and the movable body side third flat surface unit, and between the fixed body side fourth flat surface unit and the movable body side fourth flat surface unit. According to such an aspect, the viscoelastic body exhibits an effect of stabilizing a stable damper characteristic, for example, at two locations in the first direction and two locations in the second direction.

In the present invention, it is possible to adopt an aspect in which the movable body is supported on the fixed body to be movable in the drive direction by only the viscoelastic body. According to such a configuration, it is unnecessary to support the movable body by using a spring member, so that the configuration can be simplified.

In the present invention, it is possible to adopt an aspect in which the fixed body includes a case including the fixed body side first flat surface unit, the fixed body side second flat surface unit, the fixed body side second flat surface unit, and the fixed body side fourth flat surface unit, and a coil holder configured to hold a coil of the magnetic drive mechanism inside the case, and the movable body includes a first yoke in which the movable body side first flat surface unit, the movable body side second flat surface unit, the movable body side second flat surface unit, and the movable body side fourth flat surface unit are bent, as a side plate unit, from an end plate unit located at one side in the drive direction toward between the coil and the case, and a permanent magnet configuring the magnet drive mechanism with the coil while being fixed at the end plate unit to face the coil, and a second yoke arranged at an opposite side of the end plate unit with respect to the permanent magnet.

In the present invention, it is possible to adopt an aspect in which the case includes a first flat plate unit facing the first direction, a second flat plate unit facing parallel, in the first direction, to the first flat plate unit, a third flat plate unit facing the second direction, and a fourth flat plate unit facing parallel, in the second direction, to the third flat plate unit, the fixed body side first flat surface unit is formed of a first fixed plate fixed to an outer surface of the first flat plate unit to cover an opening formed in the first flat plate unit, the fixed body side second flat surface unit is formed of a second fixed plate fixed to an outer surface of the second flat plate unit to cover an opening formed in the second flat plate unit, the fixed body side third flat surface unit is formed of a third fixed plate fixed to an outer surface of the third flat plate unit to cover an opening formed in the third flat plate unit, and the fixed body side fourth flat surface unit is formed of a fourth fixed plate fixed to an outer surface of the fourth flat plate unit to cover an opening formed in the fourth flat plate unit. According to such an aspect, it is possible to provide the viscoelastic body to pass through the opening after the movable body is arranged inside the case. Therefore, it is easy to provide the viscoelastic body in the linear actuator.

In the present invention, it is possible to adopt an aspect in which the permanent magnet includes a first magnet having an N pole and an S pole next to each other in the drive direction and a second magnet being arranged at a position next to the first magnet in the drive direction and having an N pole and an S next to each other in the drive direction, and in the first magnet and the second magnet, the same poles are faced to each other between the first magnet and the second magnet. According to such a configuration, the density of the magnetic field interlinked with the coil can be increased.

In the present invention, it is possible to adopt an aspect in which the first magnet and the second magnet are joined via a magnetic plate. According to such a configuration, it is easy to join the first magnet and the second magnet at the same polarity side, as compared with a case where the first magnet and the second magnet are directly joined.

In the present invention, it is possible to adopt an aspect where the viscoelastic body is formed of a gel-like damper member.

### Advantageous Effects of Invention

In the present invention, a viscoelastic body is provided between a fixed body and a movable body, and the viscoelastic body is arranged between a fixed body side flat surface unit (a fixed body side first flat surface unit and a fixed body side second flat surface unit) facing a first direction orthogonal to a drive direction in the fixed body, and a movable body side flat surface unit (a movable body side first flat surface unit and a movable body side second flat surface unit) facing parallel, in the first direction, to the fixed body side flat surface unit in the movable body. Therefore, when the movable body moves in the drive direction, the viscoelastic body undergoes shear deformation, and a generated restoring force is applied to the movable body. Here, the restoring force occurring when the viscoelastic body undergoes the shear deformation is smaller in degree of deformation than the restoring force when the viscoelastic body is expanded or contracted. Therefore, when the movable body moves, a change in magnitude of the restoring force received by the movable body from the viscoelastic body is small. Therefore, since the viscoelastic body stabilizes a stable damper characteristic, the movable body can be properly driven. In addition, since the viscoelastic body is provided on the flat surface unit (the fixed body side flat surface unit and the movable body side flat surface unit), the viscoelastic body can be fixed to the fixed body side and the movable body side without generating a gap or the like. Therefore, even if the movable body is repeatedly vibrated, it is less likely that a problem such as peeling of the viscoelastic body from the fixed body side or the movable body side occurs. In addition, the fixed body side flat surface unit and the movable body side flat surface unit are facing parallel with each other, and thus, the viscoelastic body applies a substantially constant restoring force to the movable body throughout the entire body, so that the viscoelastic body stabilizes the damper characteristic.

### BRIEF DESCRIPTION OF THE DRAWINGS

FIG. 1 is a perspective view illustrating an appearance and the like of a linear actuator to which the present invention is applied.

FIG. 2 is an X-Z sectional view of the linear actuator illustrated in FIG. 1.

FIG. 3 is an X-Y sectional view of the linear actuator illustrated in FIG. 1.

FIG. 4 is an exploded perspective view illustrating a state where a case is removed from the linear actuator illustrated in FIG. 1.

FIG. 5 is an exploded perspective view illustrating a state where a movable body is removed from the linear actuator illustrated in FIG. 1.

FIG. 6 is an exploded perspective view illustrating a state where a first yoke is removed from the movable body illustrated in FIG. 5.

FIG. 7 is an exploded perspective view illustrating a state where a second yoke and the like are removed from the movable body illustrated in FIG. 5.

### DESCRIPTION OF THE EMBODIMENT

An embodiment of the present invention will be described with reference to the drawings. It is noted that in the following description, description proceeds where Z is allotted to a drive direction of a movable body 6, Z1 is allotted to one side in the drive direction Z, and Z2 is allotted to the other side thereof. Further, description proceeds where X is allotted to a first direction orthogonal to the drive direction Z, and Y is allotted to a second direction orthogonal to the drive direction Z and the first direction X. Further, description proceeds where X 1 is allotted to one side in the first direction X, X2 is allotted to the other side in the first direction X, Y1 is allotted to one side in the second direction Y, and Y2 is allotted to the other side in the second direction Y.

(Overall Configuration)

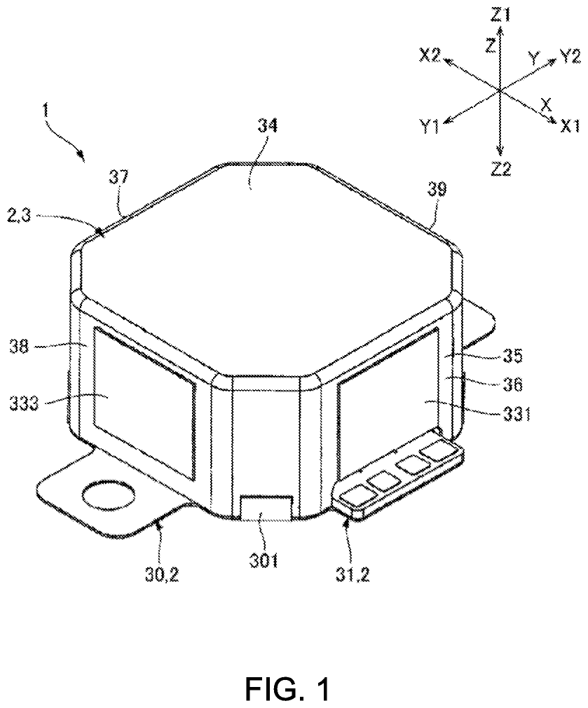

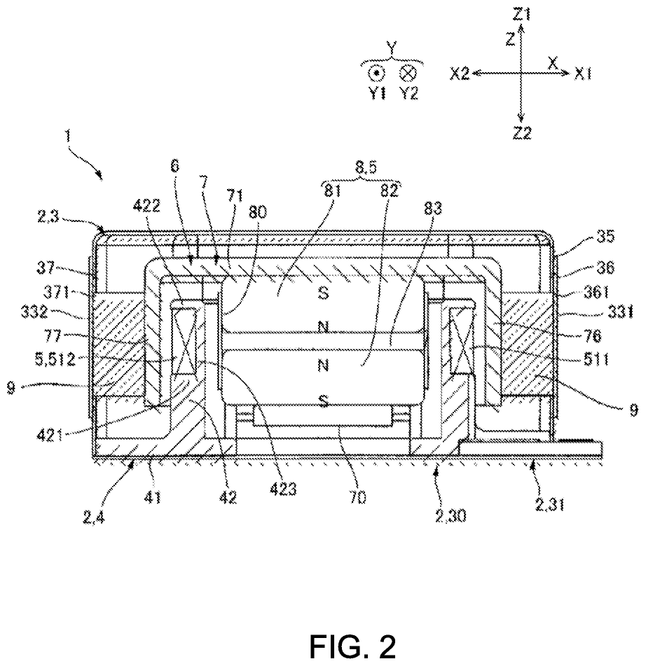

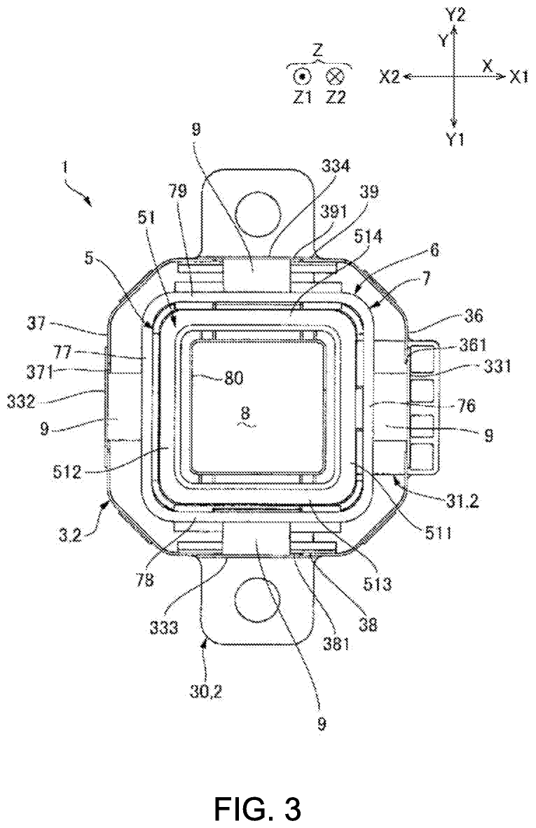

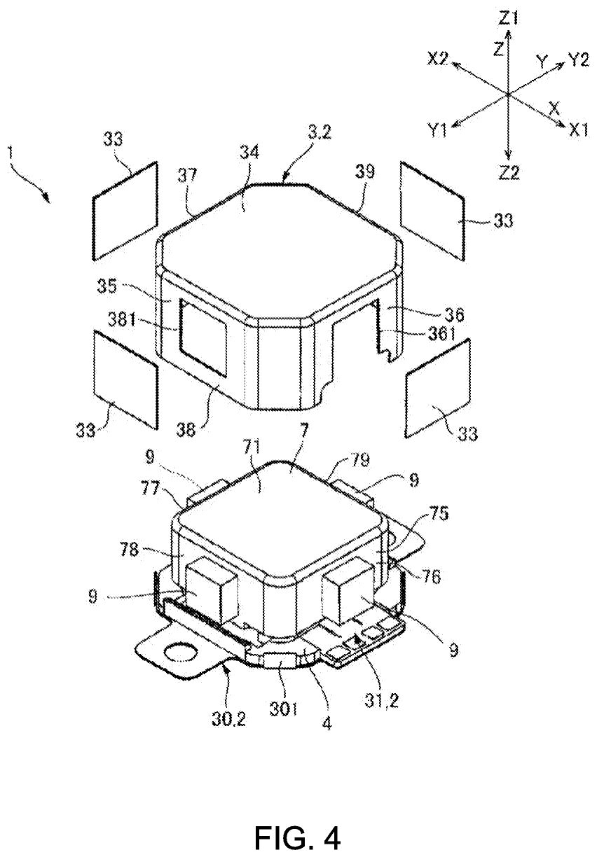

FIG. 1 is a perspective view illustrating an appearance and the like of a linear actuator 1 to which the present invention is applied. FIG. 2 is an X-Z sectional view of the linear actuator 1 illustrated in FIG. 1. FIG. 3 is an X-Y sectional view of the linear actuator 1 illustrated in FIG. 1. FIG. 4 is an exploded perspective view illustrating a state where a case 3 is removed from the linear actuator 1 illustrated in FIG. 1.

The linear actuator 1 illustrated in FIG. 1, FIG. 2, and FIG. 3 has a polygonal planar shape, and notifies a user who holds the linear actuator 1 in hand of information by way of vibration in a drive direction Z. For example, the linear actuator 1 is built in a mobile telephone or the like to notify an incoming call or the like. The linear actuator 1 can be utilized as an operation member or the like of a game machine, and a user can experience a new feeling by vibration or the like. In the present embodiment, the linear actuator 1 includes a fixed body 2, a movable body 6, a magnetic drive mechanism 5 configured to linearly drive the movable body 6 toward one side Z1 and the other side Z2 in the drive direction Z with respect to the fixed body 2. The magnetic drive mechanism 5 includes a permanent magnet 8 held by the movable body 6 and a coil 51 held by the fixed body 2. An end of the coil 51 is connected to a wiring board 31, and power is supplied to the coil 51 from the outside via the wiring board 31.

As will be described later with reference to FIG. 4 and the like, the linear actuator 1 includes a viscoelastic body 9 provided between the fixed body 2 and the movable body 6. In the present embodiment, in the linear actuator 1, a spring member or the like is not provided between the fixed body 2 and the movable body 6, and the movable body 6 is supported on the fixed body 2 movably in the drive direction Z via only the viscoelastic body 9.

### (Configuration of Fixed Body 2)

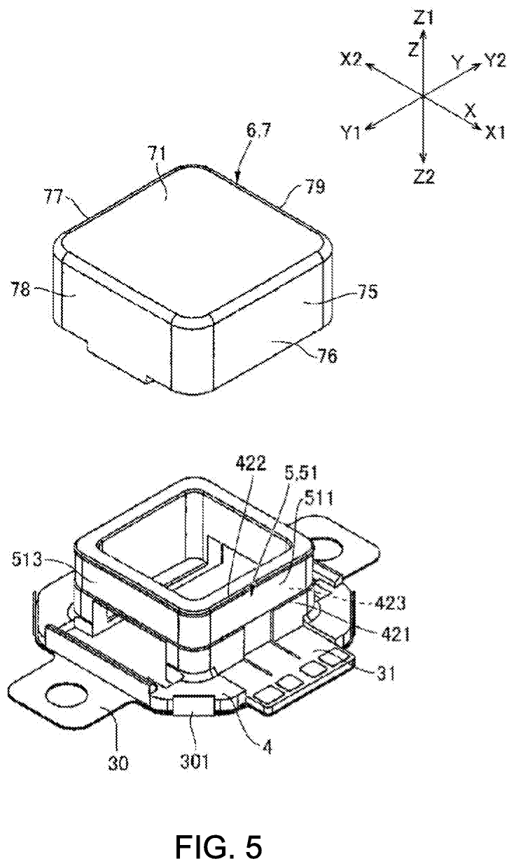

FIG. 5 is an exploded perspective view illustrating a state where the movable body 6 is removed from the linear actuator 1 illustrated in FIG. 1. The fixed body 2 includes a case 3 defining a profile of the linear actuator 1, a coil holder 4 configured to cover an open end of the case 3, a bottom plate 30 configured to fix the coil holder 4 between the bottom plate 30 and the case 3, and a wiring board 31 supported by the bottom plate. A protrusion 301 configured to position with respect to the coil holder 4 is formed in the bottom plate 30. The case 3 includes a polygonal top plate 34 located at the one side Z1 in the drive direction Z, and a polygonal cylindrical trunk 35 extending from an outer edge of the top plate 34 to the other side Z2 in the drive direction Z. In the present embodiment, the top plate 34 is octagonal, where two sides opposing in the first direction X and the two sides opposing in the second direction Y are longer than the other oblique sides. Therefore, the top plate 34 has a substantially quadrangular shape.

Therefore, the trunk 35 includes a first flat plate unit 36 whose inner surface faces the other side X2 in the first direction X, a second flat plate unit 37 facing parallel to the first flat plate unit 36 at the other side X1 in the first direction X, where its inner surface facing one side X2 in the first direction X, a third flat plate unit 38 whose inner surface faces the other side Y2 in the second direction Y, and a fourth flat plate unit 39 facing parallel to the third flat plate unit 38 at the other side X1 in the second direction Y, where its inner surface facing one side Y2 in the second direction Y. The first flat plate unit 36, the second flat plate unit 37, the third flat plate unit 38, and the fourth flat plate unit 39 are parallel to the drive direction Z.

As illustrated in FIG. 3, in each of the first flat plate unit 36, the second flat plate unit 37, the third flat plate unit 38, and the fourth flat plate unit 39, openings 361, 371, 381, and 391 are formed, where the openings 361, 371, 381, and 391 are blocked by a flat plate-like first fixed plate 331 (fixed body side first flat surface unit), second fixed plate 332 (fixed body side second flat surface unit), third fixed plate 333 (fixed body side third flat surface unit), and fourth fixed plate 334 (fixed body side fourth flat surface unit), fixed at an outer surface of each of the first flat plate unit 36, the second flat plate unit 37, the third flat plate unit 38, and the fourth flat plate unit 39. In this state, the inner surface of the first fixed plate 331 faces from the opening 361 of the first flat plate unit 36 toward the other side X2 in the first direction X, and the inner surface of the second fixed plate 332 faces from the opening 371 of the second flat plate unit 37 toward one side X1 in the first direction X to face in parallel to the first fixed plate 331 in the first direction X. Further, the inner surface of the third fixed plate 333 faces from the opening 381 of the third flat plate unit 38 toward the other side Y2 in the second direction Y, and the inner surface of the fourth fixed plate 334 faces from the opening 391 of the fourth flat plate unit 39 toward one side Y1 in the second direction Y to face in parallel to the third fixed plate 333 in the second direction Y. The first fixing plate 331, the second fixing plate 332, the third fixing plate 333, and the fourth fixing plate 334 are parallel to the drive direction Z.

As illustrated in FIG. 2, FIG. 3, FIG. 4, and FIG. 5, the coil holder 4 includes a bottom plate 41 located at an open end side of the case 3, and a square tube-like square tube unit 42 projecting from the bottom plate 41 to one side Z1 in the drive direction Z, where the square tube unit 42 is located inside the case 3. The square tube unit 42 is formed with a stepped unit 421 located at the other side Z2 in the drive direction Z, and a concave-like coil wound unit 423 between the square tube unit 42 and a flange unit 422 located at one side Z1 in the drive direction Z, where the coil 51 of the magnetic drive mechanism 5 is wound around the coil wound unit 423. In the present embodiment, the square tube unit 42 has a quadrangular planar shape. Thus, as illustrated in FIG. 3, the coil 51 includes a first side unit 511 extending in the second direction Y at one side X1 in the first direction X, a second side unit 512 extending in the second direction Y at the other side X2 in the first direction X, a third side unit 513 extending in the first direction X at one side Y1 in the second direction Y, and a fourth side unit 514 extending in the first direction X at the other side Y2 in the second direction Y.

### (Configuration of Movable Body 6)

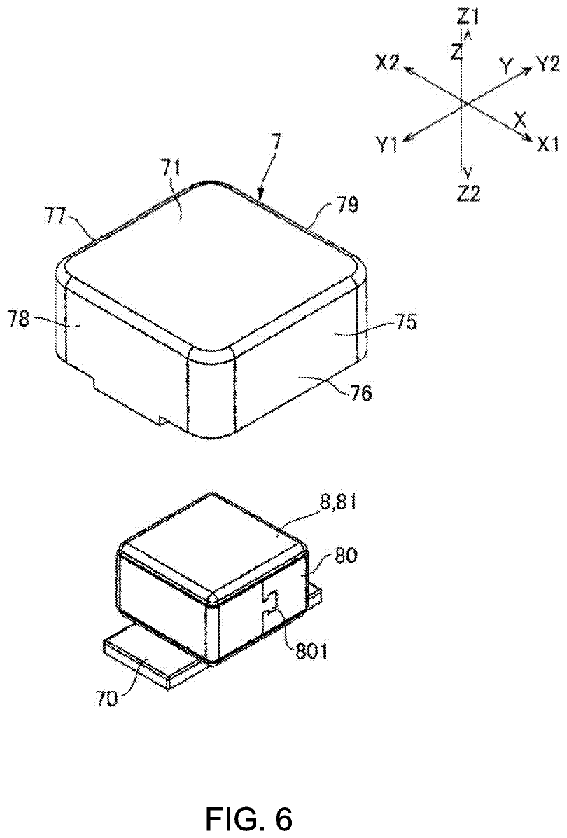

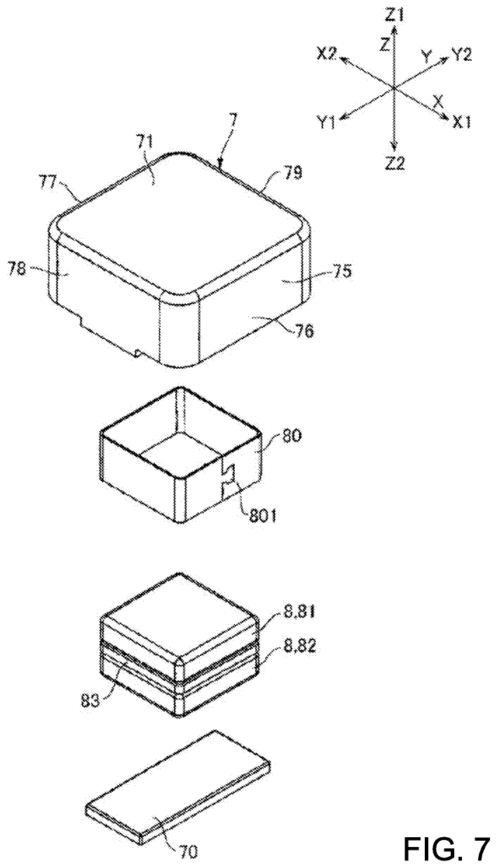

FIG. 6 is an exploded perspective view illustrating a state where a first yoke is removed from the movable body 6 illustrated in FIG. 5. FIG. 7 is an exploded perspective view illustrating a state where a second yoke and the like are removed from the movable body 6 illustrated in FIG. 5.

As illustrated in FIG. 2, FIG. 3, FIG. 5, FIG. 6, and FIG. 7, the movable body 6 includes a first yoke 7, the permanent magnet 8, a sleeve 80, and a second yoke 70. The first yoke 7 includes an end plate unit 71 located at the one side Z1 in the drive direction Z, and a trunk 75 bent from an outer edge of the end plate portion 71 toward a space between the coil 51 and the trunk 35 of the case 3. The trunk 75 includes a substantially quadrangular planar shape. Thus, as illustrated in FIG. 3, the trunk 75 includes a first side plate unit 76 (movable body side first flat surface unit) formed of a flat plate unit located between the first side unit 511 of the coil 51 and the first fixed plate 331 of the case 3 at the one side X1 in the first direction X and, a second side plate unit 77 (movable body side second flat surface unit) formed of a flat plate unit located between the second side unit 512 of the coil 51 and the second fixed plate 332 of the case 3 at the other side X2 in the first direction X. In addition, the trunk 75 includes a third side plate unit 78 (movable body side third flat surface unit) formed of a flat plate unit located between the third side unit 513 of the coil 51 and the third fixed plate 333 of the case 3 at the one side Y1 in the second direction Y and, a fourth side plate unit 79 (movable body side fourth flat surface unit) formed of a flat plate unit located between the fourth side unit 514 of the coil 51 and the fourth fixed plate 334 of the case 3 at the other side Y2 in the second direction Y. The first side plate unit 76, the second side plate unit 77, the third side plate unit 78, and the fourth side plate unit 79 are parallel to the drive direction Z.

In the movable body 6, the permanent magnet 8 is fixed to an inner surface of the end plate unit 71 of the first yoke 7, and the permanent magnet 8 faces the coil 51 in the first direction X and the second direction Y to configure, together with the coil 51, the magnetic drive mechanism 5 configured to linearly drive the movable body 6 in the drive direction Z. Further, at an opposite side of the end plate unit 71 relative to the permanent magnet 8, the plate-like second yoke 70 is laminated.

The permanent magnet 8 includes a first magnet 81 arranged at the one side Z1 in the drive direction Z, and a second magnet 82 arranged at a position next to the first magnet 81 at the other side Z2 in the drive direction Z, where each of the first magnet 81 and the second magnet 82 is magnetized so that an N pole and an S pole are next to each other in the drive direction Z. Here, in the first magnet 81 and the second magnet 82, the same poles are faced with each other between the first magnet 81 and the second magnet 82. For example, in the first magnet 81, a side of the second magnet 82 is magnetized to the N pole and a side opposite to the second magnet 82 is magnetized to the S pole. In the second magnet 82, a side of the first magnet 81 is magnetized to the N pole and a side opposite to the first magnet 81 is magnetized to the S pole.

In the present embodiment, the first magnet 81 and the second magnet 82 are joined via a magnetic plate 83. More specifically, the first magnet 81 is joined to the magnetic plate 83 with an adhesive, and the second magnet 82 is joined to the magnetic plate 83 with an adhesive. In the present embodiment, the first magnet 81, the magnetic plate 83, and the second magnet 82 are covered with the square tube-like sleeve 80, and an inner surface of the sleeve 80 is joined to the first magnet 81, the magnetic plate 83, and the second magnet 82 with an adhesive. The sleeve 80 is formed of a sheet member of which ends 801 in a circumferential direction are coupled.

### (Configuration of Viscoelastic Body 9)

As illustrated in FIG. 2, FIG. 3, and FIG. 4, the viscoelastic body 9 is in the shape of a flat plate having a constant thickness, and is arranged between a fixed body side flat surface unit facing the first direction X in the fixed body 2, and a movable body side flat surface unit facing parallel to the fixed body side flat surface unit in the first direction X in the movable body 6. In addition, the viscoelastic body 9 is arranged between a fixed body side flat surface unit facing the second direction Y in the fixed body 2, and a movable body side flat surface unit facing parallel to the fixed body side flat surface unit in the movable body 6.

More specifically, firstly, with a plate thickness direction facing the first direction X, the viscoelastic body 9 is arranged between the first fixed plate 331 (fixed body side first flat surface unit) of the case 3 and the first side plate unit 76 (movable body side first flat surface unit) of the first yoke 7, and is joined to the first fixed plate 331 and the first side plate unit 76 through the opening 361 of the first flat plate unit 36. Further, with a plate thickness direction facing the first direction X, the viscoelastic body 9 is arranged between the second fixed plate 332 (fixed body side second flat surface unit) of the case 3 and the second side plate unit 77 (movable body side second flat surface unit) of the first yoke 7, and is joined to the second fixed plate 332 and the second side plate unit 77 through the opening 371 of the second flat plate unit 37. Further, with a plate thickness direction facing the second direction Y, the viscoelastic body 9 is arranged between the third fixed plate 333 (fixed body side third flat surface unit) of the case 3 and the third side plate unit 78 (movable body side third flat surface unit) of the first yoke 7, and is joined to the third fixed plate unit 38 and the third side plate unit 78 through the opening 381 of the third flat plate unit 38. Further, with a plate thickness direction facing the second direction Y, the viscoelastic body 9 is arranged between the fourth fixed plate 334 (fixed body side fourth flat surface unit) of the case 3 and the fourth side plate unit 79 (movable body side fourth flat surface unit) of the first yoke 7, and is joined to the fourth fixed plate 334 and the fourth side plate unit 79 through the opening 391 of the fourth flat plate unit 39.

In the present embodiment, the viscoelastic body 9 is a silicone-based gel having a penetration of 10 to 110 degrees. The penetration is stipulated in JIS-K-2207 or JIS-K-2220, and the smaller this value, the harder it is. Here, viscoelasticity is a property obtained by combining both viscosity and elasticity, and is a property remarkably observed in a polymer material such as a gel-like member, a plastic, and a rubber. Therefore, various types of gel-like members can be employed as the damper members 91, 92 (viscoelastic bodies). Further, examples of the damper members 91, 92 (viscoelastic bodies) to be employed may include various types of rubber materials and a modified material thereof including natural rubber, diene-based rubber (such as styrene-butadiene rubber, isoprene rubber, and butadiene rubber), chloroprene rubber, and acrylonitrile-butadiene rubber), non-diene rubber (such as butyl rubber, ethylene-propylene rubber, ethylene-propylene-diene rubber, urethane rubber, silicone rubber, and fluororubber), and a thermoplastic elastomer.

In addition, the viscoelastic body 9 has a linear or nonlinear stretch characteristic depending on its direction of extension and contraction. For example, when the viscoelastic body 9 is compressed and deformed by being pressed in its thickness direction (axial direction), the viscoelastic body 9 has a stretch characteristic where a nonlinear component (spring coefficient) is larger than a linear component (spring coefficient). On the other hand, when extended by being pulled in the thickness direction (axial direction), the viscoelastic body 9 has a stretch characteristic where the linear component (spring coefficient) is larger than the nonlinear component (spring coefficient). As a result, if the viscoelastic body 9 is compressed and deformed by being pressed in the thickness direction (axial direction) between the movable body 3 and the support body 2, it is possible to prevent the viscoelastic body 9 from being greatly deformed, and thus, it is possible to suppress a large change in a gap between the movable body 3 and the support body 2. On the other hand, if being deformed in a direction crossing the thickness direction (axial direction) (shear direction), the viscoelastic body 9 is deformed in a direction where the viscoelastic body 9 is pulled and extended in whichever direction the motion is made, and in this case, the viscoelastic body 9 has a deformation characteristic where the linear component (spring coefficient) is larger than the nonlinear component (spring coefficient). Therefore, in the viscoelastic body 9, the spring force depending on the direction of motion is constant. Therefore, by using a spring element in the shear direction of the viscoelastic body 9, it is possible to improve a reproducibility of a vibration acceleration for an input signal, so that it is possible to achieve vibration with subtle nuances. It is noted that the fixation of the viscoelastic body 9 to the case 3 and the fixation of the viscoelastic body 9 to the first yoke 7 are performed by utilizing an adhesive, a pressure sensitive adhesive, or an adhesiveness of a silicone gel.

### (Operation and Main Effect of Present Embodiment)

In the linear actuator 1 of the present embodiment, the movable body 6 is at an origin position where a mass of the movable body 6 and a shape holding force of the viscoelastic body 9 are balanced during a period while energization to the coil 51 is suspended. In this state, if a sinusoidal wave, an inverted pulse or the like is supplied to the coil 51, the movable body 6 receives a propulsive force by the magnetic drive mechanism 5, and moves to one side Z1 in the drive direction Z against the shape holding force of the viscoelastic body 9. As a result, the viscoelastic body 9 undergoes shear deformation. An amount of movement of the movable body 6 at that time is defined by a current value supplied to the coil 51 and a restoring force of the viscoelastic body 9. If the energization to the coil 51 is stopped, the movable body 6 returns to the origin position by the restoring force of the viscoelastic body 9.

Next, if a sinusoidal wave of a reverse polarity, an inverted pulse or the like is supplied to the coil 51, the movable body 6 receives a propulsive force by the magnetic drive mechanism 5, and moves to the other side Z2 in the drive direction Z against the shape holding force of the viscoelastic body 9. As a result, the viscoelastic body 9 undergoes shear deformation. An amount of movement of the movable body 6 at that time is defined by a current value supplied to the coil 51 and a restoring force of the viscoelastic body 9. If the energization to the coil 51 is stopped, the movable body 6 returns to the origin position by the restoring force of the viscoelastic body 9.

If such a drive is repeated, the movable body 6 vibrates in the drive direction Z. A frequency of vibration at that time is defined by a frequency of a current supplied to the coil 51. Therefore, a magnitude of the vibration and the frequency are variable. It is noted that a polarity of a signal supplied to the coil 51 may be continuously switched to vibrate the movable body 6 in the drive direction Z, and in this case also, an amount of movement of the movable body 6 is determined by the value of the current supplied to the coil 51 and the restoring force of the viscoelastic body 9. Further, in a drive current, a voltage change is clearly differentiated between a negative polarity period and a positive polarity period. As a result, a difference occurs between an acceleration when the movable body 6 moves to the one side Z1 in the drive direction Z and an acceleration when the movable body 6 moves to the other side Z2 in the drive direction Z. Therefore, a user can feel an illusion that the linear actuator 1 moves toward the one side Z1 or the other side Z2 in the drive direction Z.

Here, the viscoelastic body 9 is arranged between the fixed body side flat surface unit (the first fixed plate 331 (fixed body side first flat surface unit) and the second fixed plate 332 (the fixed body side second flat surface unit) facing the first direction X orthogonal to the drive direction Z in the fixed body 2, and the movable body side flat surface unit (the first side plate unit 76 (the movable body side first flat surface unit) and the second side plate unit 77 (the movable body side second flat surface unit) facing parallel, in the first direction X, to the fixed body side flat surface unit in the movable body 6. Thus, when the movable body 6 moves in the drive direction Z, the viscoelastic body 9 undergoes shear deformation, and a generated restoring force is applied to the movable body. Therefore, the viscoelastic body 9 absorbs the vibration of the movable body 6 while deforming following the movement of the movable body 6. Therefore, unnecessary vibration of the movable body 6 can be suppressed. Here, the restoring force occurring when the viscoelastic body 9 undergoes the shear deformation is smaller in degree of deformation than the restoring force when the viscoelastic body 9 is expanded or contracted. Therefore, when the movable body 6 moves, a change in magnitude of the restoring force received by the movable body 6 from the viscoelastic body 9 is small. Therefore, since the viscoelastic body 9 stabilizes a stable damper characteristic, the movable body 6 can be properly driven. In addition, since the viscoelastic body 9 is provided on the flat surface unit (the fixed body side flat surface unit and the movable body side flat surface unit), the viscoelastic body 9 can be fixed to the fixed body 2 side and the movable body 6 side without generating a gap or the like. Therefore, even if the movable body 6 is repeatedly vibrated, it is less likely that a problem such as peeling of the viscoelastic body 9 from the fixed body 2 side or the movable body 6 side occurs. In addition, the fixed body side flat surface unit and the movable body side flat surface unit face parallel to each other, and thus, the viscoelastic body 9 applies a substantially constant restoring force to the movable body 6 throughout the entire body, so that the viscoelastic body 9 stabilizes the damper characteristic.

Further, the viscoelastic body 9 also is arranged between the fixed body side flat surface unit (the third fixed plate 333 (the fixed body side third flat surface unit) and the fourth fixed plate 334 (the fixed body side fourth flat surface unit) facing the second direction Y orthogonal to the drive direction Z and the first direction X in the fixed body 2, and the movable body side flat surface unit (the third side plate unit 78 (movable body side third flat surface unit) and the fourth side plate unit 79 (the movable body side second flat surface unit) facing parallel, in the second direction Y, to the fixed body side flat surface unit in the movable body 6. For this reason, the viscoelastic body 9 has an effect of stabilizing a stable damper characteristic, for example, at two locations in the first direction X and two locations in the second direction Y.

Further, the viscoelastic body 9 is a silicone-based gel having a penetration of 10 to 110 degrees. Therefore, the viscoelastic body 9 has elasticity enough to exhibit a damper function, and it is less likely that the viscoelastic body 9 breaks and scatters. In addition, since the viscoelastic body 9 is bonded and fixed to both the movable body 6 and the fixed body 2, it is possible to prevent the viscoelastic body 9 from moving due to the movement of the movable body 6.

In addition, the movable body 6 is supported movably on the fixed body 2 to be movable in the drive direction Z only by the viscoelastic body 9. Therefore, unlike a case where the spring member is used, resonance resulting from the spring member does not occur.

Further, the viscoelastic body 9 is arranged between a side plate unit (the first side plate unit 76, the second side plate unit 77, the third side plate unit 78, and the fourth side plate unit 79) of the first yoke 7 and a fixing plate 331 (the first fixing plate 331, the second fixing plate 332, the third fixing plate 333, and the fourth fixing plate 334) of the case 3. Thus, after the movable body 6 is arranged inside the case 3, it is possible to provide the viscoelastic body 9 from the outside to pass through the openings 361, 371, 381, and 391. Therefore, it is easy to arrange the viscoelastic body 9 in the linear actuator 1.

Further, in the permanent magnet 8, since the same pole is directed between the first magnet 81 and the second magnet 82 in the first magnet 81 and the second magnet 82, a magnetic field density generated between the first magnet 81 and the second magnet 82 (magnetic plate 83) is high. Therefore, since the density of the magnetic field interlinked with the coil 51 can be increased, the magnetic drive mechanism 5 can generate a large thrust. Even in this case, since the first magnet 81 and the second magnet 82 are joined via the magnetic plate 83, as compared with a case where the first magnet 81 and the second magnet 82 are directly joined, it is easy to join the first magnet 81 and the second magnet 82 at the same polarity side.

### Other Embodiments

In the above embodiment, a spring member configured to support the movable body 6 is not provided in the linear actuator 1; however, a spring member configured to support the movable body 6 may be provided.

Further, in the above-described embodiment, the viscoelastic body 9 is fixed to the fixed body 2 and the movable body 6 by way of an adhesion or the like; however, after a precursor for forming the viscoelastic body 9 is provided, the precursor is gelled, and the viscoelastic body 9 may be fixed to the fixed body 2 and the movable body 6 by an adhesive force of the viscoelastic body 9 itself.

Further, in the present embodiment, the first magnet 81 and the second magnet 82 are joined via the magnetic plate 83. However, the present invention is not limited thereto. For example, it may be configured so that the first magnet 81 and the second magnet 82 are magnetized to be faced by one permanent magnet, for example, in the drive direction Z illustrated in FIG. 1, a permanent magnet magnetized in an intermediate portion to the same pole (N pole, N pole) and magnetized in the opposite side to S pole, S pole may be employed.

### REFERENCE SIGNS LIST

1 . . . Linear actuator, 2 . . . Fixed body, 3 . . . Case, 4 . . . Coil holder, 5 . . . Magnetic drive mechanism, 6 . . . Movable body, 7 . . . First yoke, 8 . . . Permanent magnet, 9 . . . Viscoelastic body, 34 . . . top plate, 36 . . . First flat plate unit, 37 . . . Second flat plate unit, 38 . . . Third flat plate unit, 39 . . . Fourth flat plate unit, 51 . . . Coil, 70 . . . Second yoke, 71 . . . End plate unit, 76 . . . First side plate unit (movable body side first flat surface unit), 77 . . . Second side plate unit (movable body side second flat surface unit), 78 . . . Third side plate unit (movable body side third flat surface unit), 79 . . . Fourth side plate unit (movable body side fourth flat surface unit), 80 . . . Sleeve, 81 . . . First magnet, 82 . . . Second magnet, 83 . . . Magnetic plate, 331 . . . First fixed plate (fixed body side first flat surface unit), 332 . . . Second fixed plate (fixed body side second flat surface unit), 333 . . . Third fixed plate (fixed body side third flat surface unit), 334 . . . Fourth fixed plate (fixed body side fourth flat surface unit), 361, 371, 381, 391 . . . Opening, 421 . . . Stepped unit, 422 . . . Flange unit, 423 . . . Coil wound unit, X . . . First direction, Y . . . Second direction, Z . . . Drive direction

1. A linear actuator, comprising:
a fixed body;
a movable body;
a magnetic drive mechanism configured to linearly drive the movable body with respect to the fixed body; and
a viscoelastic body provided between the fixed body and the movable body, wherein
the fixed body includes a fixed body side first flat surface unit facing a first direction orthogonal to a drive direction and a fixed body side second flat surface unit facing parallel, in the first direction, to the first flat surface unit,
the movable body includes a movable body side first flat surface unit facing parallel, in the first direction, to the fixed body side first flat surface unit, and a movable body side second flat surface unit facing parallel, in the first direction, to the fixed body side second flat surface unit, and
the viscoelastic body is provided between the fixed body side first flat surface unit and the movable body side first flat surface unit and between the fixed body side second flat surface unit and the movable body side second flat surface unit.

2. The linear actuator according to claim 1, wherein the fixed body includes a fixed body side third flat surface unit facing a second direction orthogonal to the drive direction and the first direction and a fixed body side fourth flat surface unit facing parallel, in the second direction, to the fixed body side third flat surface unit,
the movable body includes a movable body side third flat surface unit facing parallel, in the second direction, to the fixed body side third flat surface unit, and a movable body side fourth flat surface unit facing parallel, in the second direction, to the fixed body side second flat surface unit, and
the viscoelastic body is further provided between the fixed body side third flat surface unit and the movable body side third flat surface unit, and between the fixed body side fourth flat surface unit and the movable body side fourth flat surface unit.

3. The linear actuator according to claim 2, wherein the movable body is supported on the fixed body to be movable in the drive direction only by the viscoelastic body.

4. The linear actuator according to claim 2, wherein the fixed body includes a case including the fixed body side first flat surface unit, the fixed body side second flat surface unit, the fixed body side third flat surface unit, and the fixed body side fourth flat surface unit, and a coil holder configured to hold a coil of the magnetic drive mechanism inside the case, and
the movable body includes a first yoke in which the movable body side first flat surface unit, the movable body side second flat surface unit, the movable body side third flat surface unit, and the movable body side fourth flat surface unit are bent, as a side plate unit, from an end plate unit located at one side in the drive direction toward between the coil and the case, and a permanent magnet configuring the magnet drive mechanism with the coil while being fixed at the end plate unit to face the coil, and a second yoke arranged at an opposite side of the end plate unit with respect to the permanent magnet.

5. The linear actuator according to claim 4, wherein the case includes a first flat plate unit facing the first direction, a second flat plate unit facing parallel, in the first direction, to the first flat plate unit, a third flat plate unit facing the second direction, and a fourth flat plate unit facing parallel, in the second direction, to the third flat plate unit,
the fixed body side first flat surface unit is formed of a first fixed plate fixed to an outer surface of the first flat plate unit to cover an opening formed in the first flat plate unit,
the fixed body side second flat surface unit is formed of a second fixed plate fixed to an outer surface of the second flat plate unit to cover an opening formed in the second flat plate unit,
the fixed body side third flat surface unit is formed of a third fixed plate fixed to an outer surface of the third flat plate unit to cover an opening formed in the third flat plate unit, and
the fixed body side fourth flat surface unit is formed of a fourth fixed plate fixed to an outer surface of the fourth flat plate unit to cover an opening formed in the fourth flat plate unit.

6. The linear actuator according to claim 4, wherein the permanent magnet includes a first magnet having an N pole and an S pole next to each other in the drive direction and a second magnet being arranged at a position next to the first magnet in the drive direction and having an N pole and an S pole next to each other in the drive direction, and
in the first magnet and the second magnet, the same poles are faced to each other between the first magnet and the second magnet.

7. The linear actuator according to claim 6, wherein the first magnet and the second magnet are joined via a magnetic plate.

8. The linear actuator according to claim 3, wherein the viscoelastic body is formed of a gel-like damper member.

9. The linear actuator according to claim 5, wherein the permanent magnet includes a first magnet having an N pole and an S pole next to each other in the drive direction and a second magnet being arranged at a position next to the first magnet in the drive direction and having an N pole and an S pole next to each other in the drive direction, and
in the first magnet and the second magnet, the same poles are faced to each other between the first magnet and the second magnet.

10. The linear actuator according to claim 9, wherein the first magnet and the second magnet are joined via a magnetic plate.

11. The linear actuator according to claim 3, wherein the fixed body includes a case including the fixed body side first flat surface unit, the fixed body side second flat surface unit, the fixed body side third flat surface unit, and the fixed body side fourth flat surface unit, and a coil holder configured to hold a coil of the magnetic drive mechanism inside the case, and
the movable body includes a first yoke in which the movable body side first flat surface unit, the movable body side second flat surface unit, the movable body side third flat surface unit, and the movable body side fourth flat surface unit are bent, as a side plate unit, from an end plate unit located at one side in the drive direction toward between the coil and the case, and a permanent magnet configuring the magnet drive mechanism with the coil while being fixed at the end plate unit to face the coil, and a second yoke arranged at an opposite side of the end plate unit with respect to the permanent magnet.

12. The linear actuator according to claim 1, wherein the viscoelastic body is formed of a gel-like damper member.

13. The linear actuator according to claim 2, wherein the viscoelastic body is formed of a gel-like damper member.

14. The linear actuator according to claim 4, wherein the viscoelastic body is formed of a gel-like damper member.
